(19) United States
(12) Patent Application Publication
(10) Pub. No.: US 2014/0214961 A1
(43) Pub. Date: Jul. 31, 2014

(54) Methods and systems for continuous compilation of non-interactive video with supplemental renderings of interactive content to produce real-time, personalized video for individuals and/or groups in a shared experience

(71) Applicant: LANCE GORDON DOUGLAS, OLDS (CA)

(72) Inventor: LANCE GORDON DOUGLAS, OLDS (CA)

(21) Appl. No.: 14/167,672

(22) Filed: Jan. 29, 2014

Related U.S. Application Data
(60) Provisional application No. 61/758,789, filed on Jan. 31, 2013.

(51) Int. Cl. H04L 29/06

(52) U.S. Cl. CPC H04L 65/403
USPC 709/204

(57) ABSTRACT

The invention is a method for real-time compilation of linear non-interactive media content (multicast/unicast video and/or audio) along with supplemental interactive-content to create new linear media content. The invention includes the systems and processes to support the creation and/or integration of the supplemental interactive-content via interactive-devices controlled by consuming participants of the compilation, and where the compilation is presented as a single linear media with or without further interaction, and each consumer of the compilation is capable of receiving and/or influencing uniquely personalized supplemental content to be utilized in the compilation. The invention combines computer servers, computer networks, human and computer processes, registration and management computer-interfaces, and multi-modality-media compilation servers.

The invention is a method for real-time compilation of linear non-interactive media content (multicast/unicast video and/or audio) along with supplemental interactive-content to create new linear media content.

The invention includes the systems and processes to support the creation and/or integration of the supplemental interactive-content via interactive-devices controlled by consuming participants of the compilation, and where the compilation is presented as a single linear media with or without further interaction, and each consumer of the compilation is capable of receiving and/or influencing uniquely personalized supplemental content to be utilized in the compilation. The invention combines computer servers, computer networks, human and computer processes, registration and management computer-interfaces, and multi-modality-media compilation servers.

1. A set of systems and processes (collectively: “environment”), which allow people to participate together, whether as a limited group or as general public, in the consumption of linear non-interactive media content (e.g. video, motion-graphics, audio) which is supplemented with companion-elements, which combine into an unified visual media (i.e. video) within the original presentation medium (“consumption-device”) of the linear non-interactive visual media (collectively: “compilation”), where the environment is aware of each participant's identity and/or other characterizing information (collectively: “knowledge”), and where the environment utilizes that knowledge to apply personalization to the companion-elements of the compilation, and where the interaction primarily occurs on other devices (“interaction-device”), and where the result of the interaction is synchronously presented within, or as, the companion-elements of the compilation uniquely for all, or some, participants.

2. A method according to claim 1, wherein said interaction devices are all connected via a computer internetwork.

3. A method according to claim 1, wherein said supplemental companion-elements comprises audible, graphical, and/or textual items rendered a streaming video.

4. A method according to claim 1, wherein said companion-elements are arranged for presentation, on the consumption-device, in real-time relative to the playback of the linear non-interactive visual media.

5. A method according to claim 4, wherein said consumption-device is a video-display screen (e.g. monitor or television).

6. A method according to claim 1, wherein said participation-group management is managed by the environment or one or more participants.

7. A method according to claim 6, wherein said management is performed to arrange a situation similar to an invite or opt-in opportunity for certain, or any, persons on a one-time, or ongoing, arrangement to participate and/or consume partially or fully.

8. A method according to claim 7, wherein said performance of management is the act of one, or some, of the following: selecting participants, appointing roles, appointing functionality to roles, choosing what knowledge is acquired by the environment and how it is used, choosing what companion-elements are available, choosing whether companion-elements are mandatory or optional for the said intended compilation, choosing the linear non-interactive content to be included in the compilation, choosing how the non-interactive and companion-elements are arranged in the compilation relative to the linear non-interactive content

9. A method according to claim 8, wherein said choosing of the linear non-interactive content is the selection, or defining, of a media source, such as a multicast or unicast media stream from a source configured, or configurable, to be available within the environment.

10. A method according to claim 9, wherein said availability for configuration within the environment is a URL or Television Broadcast Channel that is accessible via the computer internetwork of the environment.

11. A method according to claim 1, wherein said identifying information is one or more data associated directly, and uniquely, with each person registered to be a participant of the environment.

12. A method according to claim 1, wherein said characterizing information is one or more data that provides environmental, physical state, tangible, or intangible information in one or more combinations of each, or some, participants where that information relates to the person, place, devices, or other available information linkable to the said participant.

13. A method according to claim 12, wherein said linkable information comprises of directly and/or indirectly publically available data, privately provided information, or any combination of the two, wherein the information is accessible to the environment via data storage or internetwork communications.

14. A method according to claim 1, wherein said interaction-devices comprise of a computer internetwork compatible device such as a mobile-phone, personal computer, portable computer, tablet computer, or any other device with a human-computer-interface designed to capture human input.

15. A method according to claim 1, wherein said real-time refers to live presentation of, or playback of recorded, linear non-interactive content, wherein the timeline of the live presentation, or playback, may be manipulated via interaction of the participants' wherein the companion-elements expose sufficient interaction with the environment's systems and processes to the interaction-devices via computer-interfaces.
